(19) United States
(12) Patent Application Publication
(10) Pub. No.: US 2006/0225690 A1
(43) Pub. Date: Oct. 12, 2006

(54) Selective leverage technique and devices

(76) Inventor: Anatoly Arov, Toronto (CA)

Correspondence Address: Elias C. Borges;Suite 406, 555 Burnhamthorpe Road, Toronto, M9C 2Y3, CA

(21) Appl. No.: 11/375,198

(22) Filed: Mar. 15, 2006

Related U.S. Application Data
(60) Provisional application No. 60/662,383, filed on Mar. 17, 2005.

(30) Foreign Application Priority Data
Apr. 14, 2005 (CA) 2,504,057

(51) Int. Cl. F02D 17/02

(52) U.S. Cl. 123/198 F

(57) ABSTRACT

A non linear torque altering transmission is used in combination with an input or output device having a pulsating torque cycle characteristic. The transmission has a gear train of cooperating gears that during each cycle produce a varying leverage effect. This varying leverage effect is matched to the input/output device to improve the performance thereof. This combination is beneficial with many devices including a reciprocating piston engine, an AC compressor and wind driven turbines.

### CROSS REFERENCE TO RELATED APPLICATION

The present application claims priority from U.S. provisional patent application Ser. No. 60/662,383 filed Mar. 17, 2005, the entirety of which is incorporated herein by reference.

### FIELD OF INVENTION

The present invention relates to improved performance of a device having a pulsing input or output such as combustion engines, AC generators, compressors and other cyclically varying devices.

### BACKGROUND OF THE INVENTION

Structures to enhance the performance of internal combustion engines continued to be proposed including my own designs as set forth in Canadian Patent 2,077,275, Canadian application 2,450,542 and PCT application PCT/CA2004/001989. These designs use a rotary design as opposed to a reciprocating piston engine, to alter the transfer of the combustion force of the engine to its output shaft. Rotary engines require significant changes to the accepted manufacturing process and have not been readily adopted.

The present invention provides an intermediate solution that provides some of the advantages of my earlier structures for conventional cyclically varying input or output devices. This intermediate solution includes a SLT (Selective Leverage Technique) gear train that uses a well known leverage principle to improve the performance of engines, AC motors and generators, compressors etc.

### SUMMARY OF THE INVENTION

According to the present invention a non linear torque altering gear train is used in combination with a device having a pulsating torque cycle characteristic. The gear train comprises a gear train having a cyclic torque variation selected to cooperate with the pulsating torque characteristic of the device to improve the performance thereof by non linearly modifying during each cycle the net torque of the combination.

According to an aspect of the invention the device is an input to the gear train.

In a different aspect of the invention the gear train is an output of a piston type four stroke motor and said gear train increases the net torque output during the power stroke and decreases the net torque required during the combustion stroke. The motor may be a single cylinder or a multi-cylinder engine.

In a preferred aspect of the invention the piston type engine is a two or four cylinder engine and preferably, the gear train is defined by 2 elliptical-like gears.

In yet a further aspect of the invention the gears cooperate to provide a maximum increase in peak torque of at least 2.0.

The device can also be a driven device and in this case the gear train modifies the input force to improve the output of the driven device. This has particular application with AC generators and piston type compressors.

A further embodiment of the invention includes steam and wind turbines providing the input force for the gear train and a connected AC generator. The gear train is a varying speed cyclic transmission and the AC generator is driven at increased torque during part of its cycle to increase the power output. The gear train preferably includes two elliptical-like gears.

In a further aspect of the invention the gear train is a varying speed cyclic transmission paired to cooperate with a cyclically varying torque requirement or torque output of the device.

With the present invention, the gear train has a cyclically varying torque characteristic matched to a cyclically varying requirement or output of the device.

The present invention is also directed to using a SLT gear train to cyclically vary torque characteristics to match a cyclically varying requirement or output of a device.

### BRIEF DESCRIPTION OF THE DRAWINGS

Preferred embodiments of the invention are shown in the drawings, wherein:

FIG. 1 is a perspective view of the SLT gear train of two spur gears mounted with offset axis of rotation;

FIG. 2 is a top view of the SLT gear train using two elliptical shape gears;

FIG. 3 is a top view of the SLT gear train using two gears with three distinct gear segments;

FIG. 4 is a top view of the SLT gear train using two gears having four distinct gear segments;

FIG. 5 is a perspective view of the SLT gear train of FIG. 1;

FIGS. 6, 7, 8 and 9 are schematics of the SLT gear train used in combination with an output shaft of a piston type internal combustion engine;

FIG. 10 shows the SLT gear train that includes additional gears to allow the same direction of rotation of the input shaft to the output shaft;

FIG. 11 is a torque/degree of rotation graph; and

FIG. 12 is a schematic showing the use of the SLT gear train attached to the output shaft of an AC motor.

### DETAILED DESCRIPTION OF THE PREFERRED EMBODIMENT

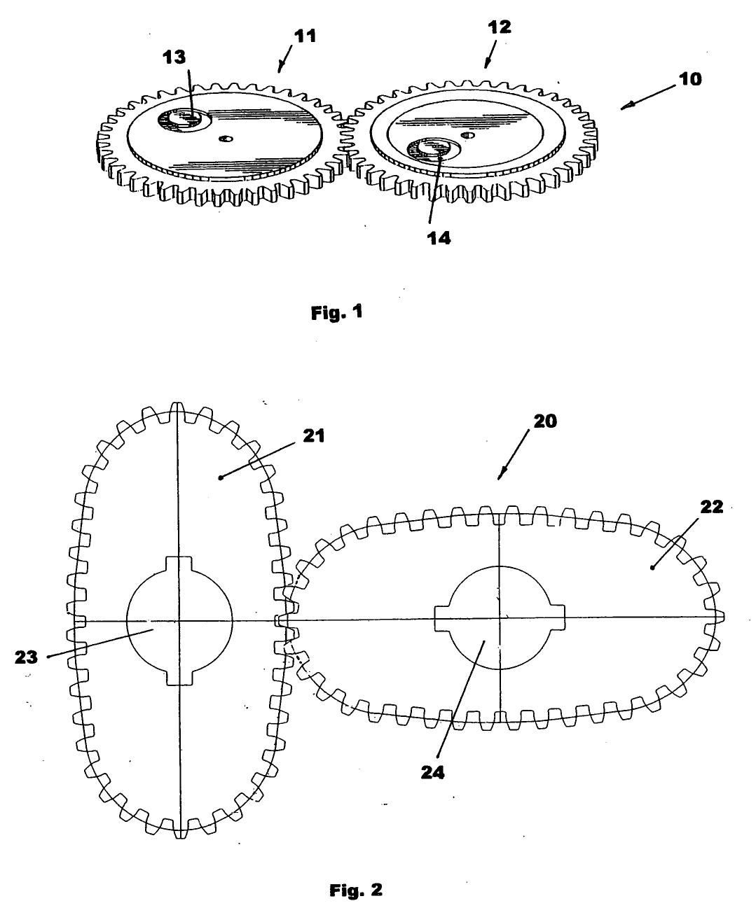

FIGS. 1 through 4 show different SLT gear train arrangements where rotation of one of the gears at a constant input/output speed produces a cyclically varying at a speed of the other gear and cyclically varying torque characteristics. These SLT gear trains have particular application with a powered device having a cyclically varying characteristic or pulsating characteristic or with a driven device having a pulsating characteristic.

The SLT gear train 10 of FIG. 1 has two circular gears 11 and 12 secured with offset axis of rotations 13 and 14. These gears are simple to make and are preferred for many of the application of the SLT gear train with a pulsating device.

The SLT gear train 20 of FIG. 2 has similar cyclically varying characteristics but uses elliptical-like gears 21 and 22 rotating about axes 23 and 24. This SLT gear train and the gears of FIG. 1 can be used with single or double piston engines or compressors to improve the output as will be discussed with respect to the later Figures.

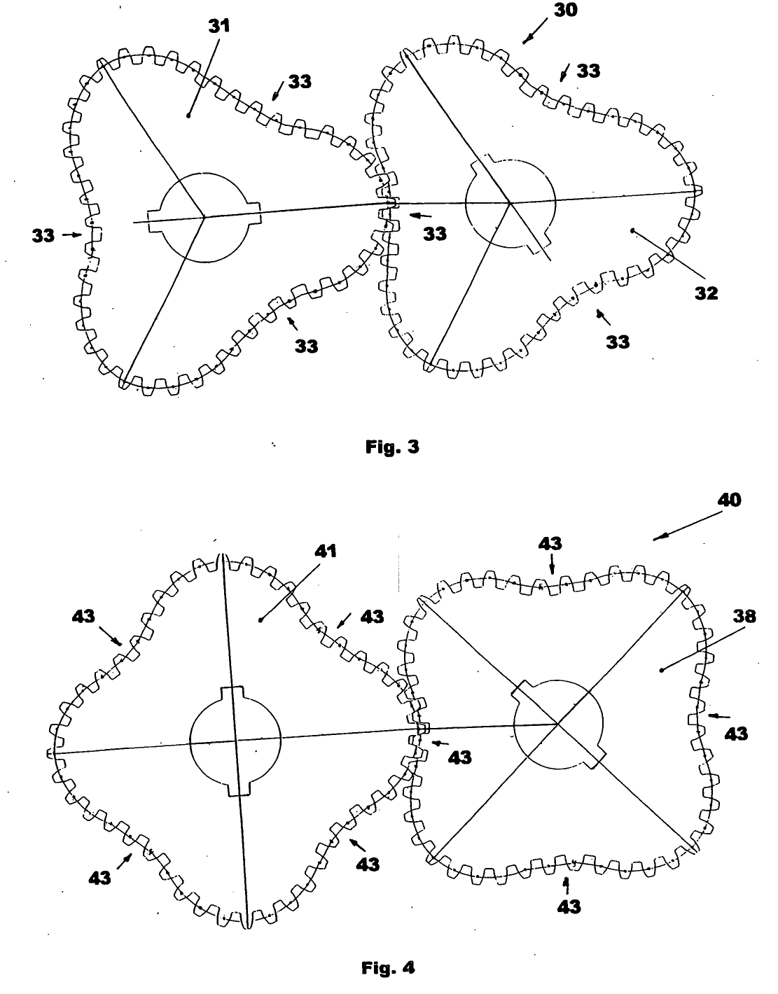

The SLT gear train 30 of FIG. 3 has two gears 31 and 32 with each gear having three changing speed segments 33 located 120 degrees apart. This SLT gear train is useful with devices having a pulsing sequence every 120 degrees.

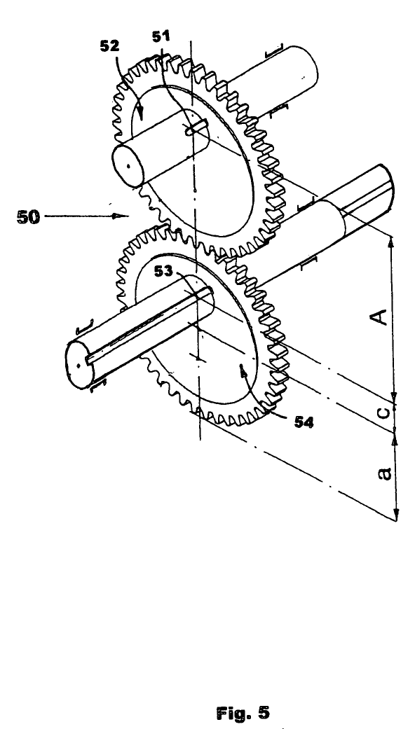

The SLT gear train 40 of FIG. 4 includes gears 41 and 42 with each gear having four gear segments 43. This SLT gear train is useful with devices having a pulsing sequence every 90 degrees.

Each of the SLT gear trains of FIGS. 1 through 5 provides a changing mechanical advantage or “lever” during each cycle. This advantage is matched or paired with cyclically varying characteristics of a driven or a drive device.

FIG. 5 is a sectional view of a SLT gear train 50 having gears 52 and 54. Gear 52 is rotated by drive shaft 51 such as an output shaft of an engine. Gear 54 is driven by gear 52 and rotates the new output shaft 53. The SLT gear train of FIG. 5 is advantageous with a two cylinder engine. The gears are elliptical-like, rotating around focal point with parameters: A=distance between centers, a=ellipse axis, c=ellipse focal distance.

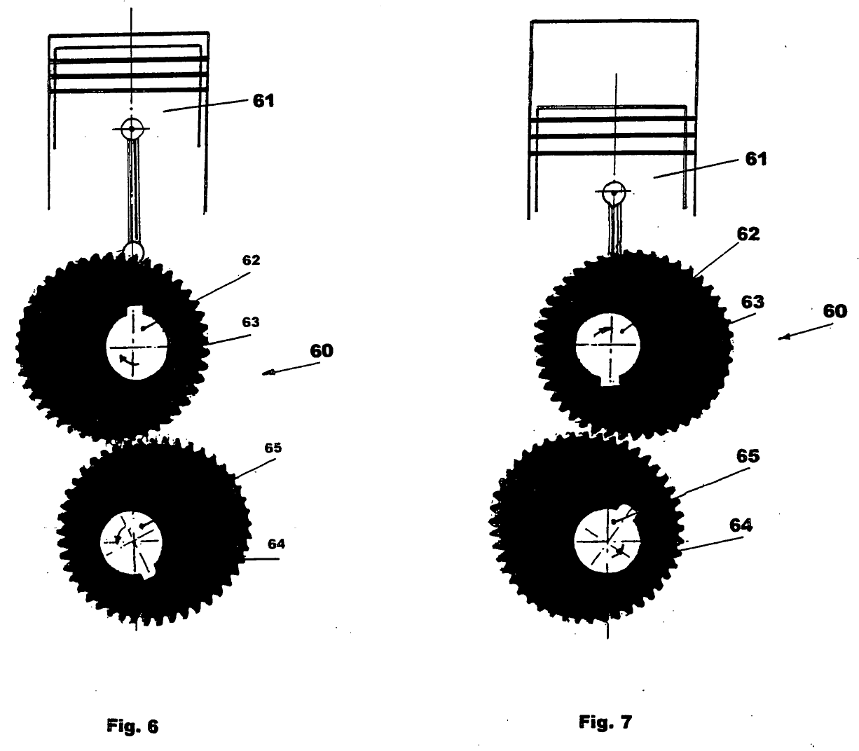

FIGS. 6 to 9 show the SLT gear train 60 paired with a one cylinder assembly 61, crankshaft 62, primary gear 63, secondary gear 64 and output shaft 65. These figures will also be explained relative to the graph of FIG. 11.

The cylinder assembly 61 of FIG. 6 has the piston starting the combustion stroke after compression of working media. The force exerted on the piston is transmitted through the connecting rod and rotates the crankshaft 62. During the next 180 degree shaft rotation, variable torque is produced as generally shown on FIG. 11,

Curve 111 indicates maximum torque being produced at about 90 degree shaft rotation. From FIG. 6 it can be understood that, if engine shaft 62 with gear 63 rotates clockwise, the torque at shaft 64 is increased due to the multiplying or leverage affect produced by the gears 63 and 64. The maximum leverage occurs at 90 degree engine shaft and gear 63 key position (assuming that ellipse bigger axis “a” FIG. 5 is perpendicular to key axis) is vertical.

The cyclically varying gear multiplier or leverage is varied from 1.2 to 2 (90 degree) and then back to 1.2; but depending on ellipse parameters, these numbers could vary. With 180 degree rotation of engine shaft 62, secondary shaft 65 rotation is less than 180 degree, and for those particular parameters equal to 110 degrees. With analysis of curve 112 FIG. 11 shows that maximum torque is produced during maximum gears leverage and in this particular case average torque magnification is approximately 60%.

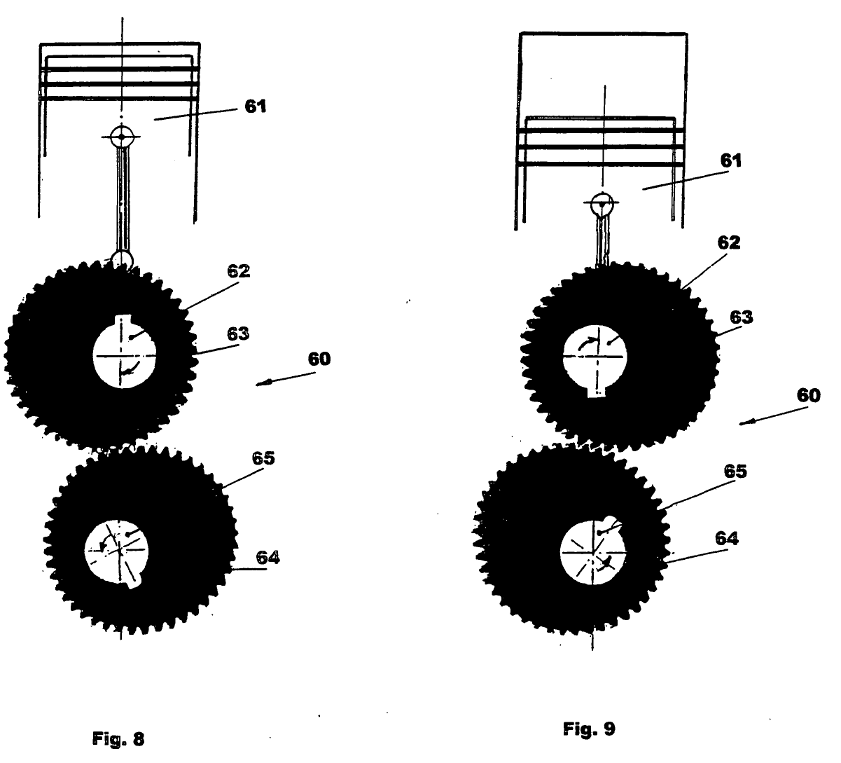

FIG. 7 shows gears position after combustion and before the exhaust stroke. During exhaust rotation (inertia) of secondary shaft 5 is pushing gases out of cylinder with higher speed and torque, because gear ratio allows to reduce energy required for exhaust.

FIG. 8 shows gears position after exhaust before suction. During suction the suction stroke the gear ratio is working as a disadvantage and in this example requires 60% more energy for suction.

FIG. 9 shows gears position after suction. During compression inertia of shaft 5 continues to provide the necessary force for compression. The gear ratio is now favorable and 60% less energy for compression is required.

FIGS. 6 to 9 provide an explanation with respect to a four stroke engine, however this advantage can also be used for two stroke engines.

For two cylinder four stroke engines with gears as described in FIGS. 1 and 5, the average leverage is between 50 and 75%.

It is important for efficiency of the present method to find point of engine maximum torque and key the leading gear of the SET gear train to provide the cyclically varying mechanical advantage.

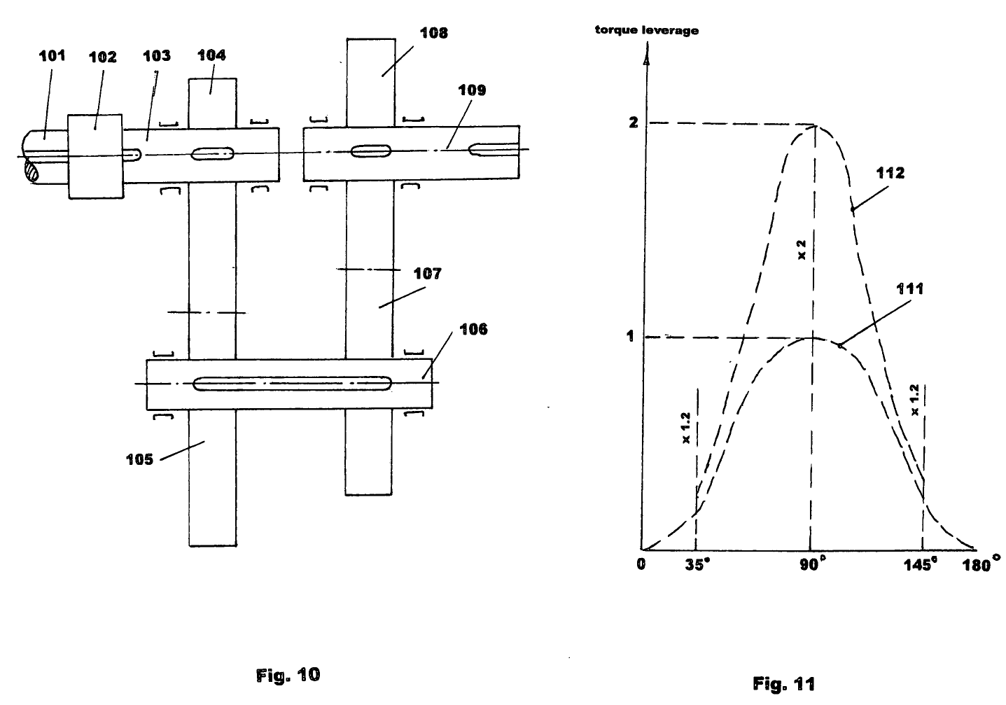

In some cases direction of rotation and alignment 5 of the SLT gear train output shaft with the original engine output shaft may be necessary or desired. FIG. 10 shows one for this purpose. In this case engine shaft 101 coupled with coupling 102 to external/internal primary shaft 103 having special gear 104 connected to satellite shaft 106 having special gear 105 and regular gear 107 transmitting rotation to regular gear 108 and shaft 109 which is aligned with original engine shaft/crankshaft. This arrangement could be incorporated into the engine, into a stationary housing or into a clutch.

In preliminary tests of a two cylinder engine using the present invention, the average torque increase is approximately 50% and with the same rpm (rotation per minute) allows 50% engine power increase. Similar or increased benefits may be realized for 4, 6 and 8 cylinder engines.

For increased understanding the following specific examples are provided. With a four cylinder engine, combustion is performed every 180 degree (four stroke) and the configuration of gears pitch line as shown in FIG. 2 is advantageous. In this case leading special gear keyway alignment should be around 55 degrees clockwise or counterclockwise depending of direction of rotation (for maximum gear ratio 2) and not 90 degrees as on FIG. 6. In case of six cylinder engines, a special gear is shown on FIG. 3, having three equal sections every 120 degrees. Keyway angle deviation in this case is around 35 degrees. In case of an eight cylinder engine special gear is shown on FIG. 4, having four equal sections every 90 degrees, with keyway angle deviation in this case should be around 27 degrees.

In some conditions for six and eight cylinder engines it is more economical to have extra pair of regular gears placed before pair of special gears multiplying engine rotational speed (rpm) in such way that leading special gear FIG. 2 makes 180 degree rotation for 120/90 degree of engine shaft rotation with regular gears ratio 1.5/2 accordingly. After special gears could be placed another pair of gears to reverse multiplication in case of requirement. For a single cylinder engine, the speed can be reduced by pair of regular gears with ratio 2, in combination with the SLT gear train of FIG. 1.

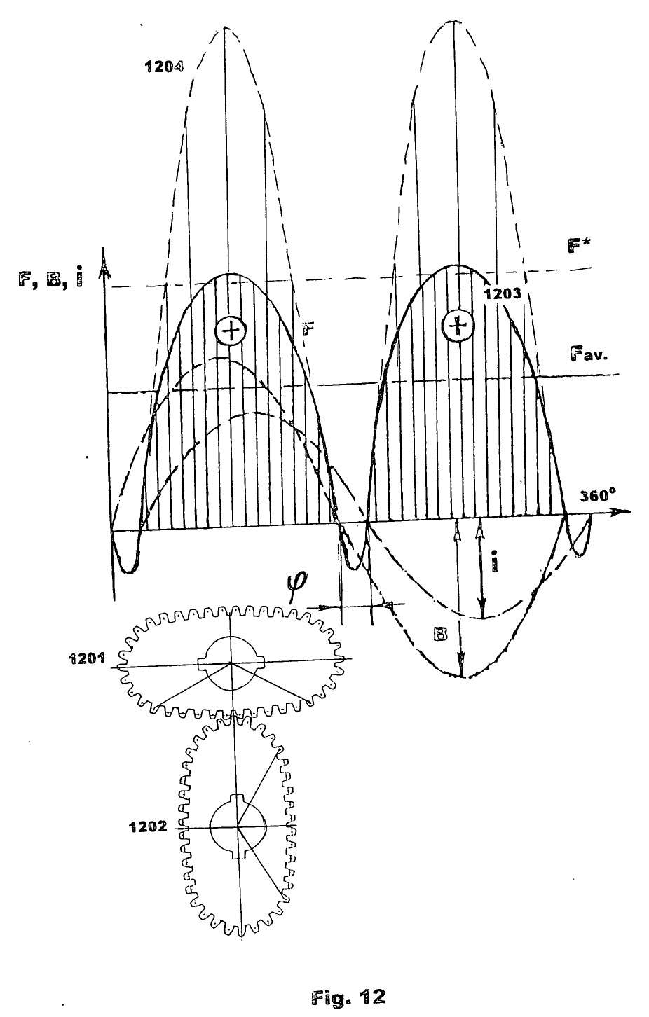

FIG. 12 illustrates the desired selective cyclical amplification of a force to improve the performance of an AC motor. An average AC motor force Fav is shown relative to the modified output force 1204. The output force created using the combination of the present invention is curve 1204 with average force (and corresponding torque) F* for a driven by AC motor device.

FIG. 12 shows example of SLT effect when adding device having two special gears connected to output shaft of single phase AC motor. Special gear 1201 is connected to AC motor shaft in such way that it creates a maximum torque for driven device connected to special gear 1202 when it required, FIG. 12 shows induction curve * and current curve I and force curve F as a result of a load to AC motor. Without SLT device FIG. 12 shows average motor force Fav and 1204 is actual force curve created by SLT device with average force (and corresponding torque) F* for driven device. If driven device is pulsing energy device (for example piston compressor) positive effect will be even greater if this device is aligned properly.

In case of AC generator, using SLT device, connected to its shaft, and driven by turbine or other source (engine, wind turbine and etc.) it will supply, if properly aligned, higher torque to rotor when required by load. Without load rotor will have maximum speed variation and with load increase this variation becomes negligent. Special gears FIG. 2 are recommended.

If the driven device is a pulsing driven device (for example a piston compressor) the positive effect will be even greater if this device is aligned properly. In case of an AC generator, using the SLT gear train connected to its shaft, and driven by turbine or other input source (engine, wind turbine and etc.) it will supply, if properly aligned, higher torque to the rotor when required by the load. Without load, the rotor will have maximum speed variation and with load the speed variation becomes negligent.

The timed mechanical advantage of the present system has been particularly described with respect to modifying the output of a pulsating drive device but it is also useful altering the input to a driven device such as a piston compressor, an AC generator or other pulsating devices having changing torque characteristics.

Although preferred embodiments of the invention have been described herein in detail it is understood that variations may be made thereto without departing from the spirit of the invention or the scope of the appended claims.

The embodiments of the invention in which an exclusive property or privilege is claimed are defined as follows:

1. A non linear torque altering transmission arrangement in combination with a device having a pulsating torque cycle characteristic; said transmission arrangement comprising a gear train for creation of a cyclic torque variation selected to cooperate with the pulsating torque characteristic of said device to improve the performance thereof by non linearly modifying during each cycle the net torque of the combination.

2. The combination of claim 1 wherein said device is an output device to said arrangement.

3. The combination as claimed in claim 2 wherein said output device is a piston type four stroke motor and said gear train increases the net torque output during the power stroke and decreases the net torque required during the compression stroke.

4. The combination as claimed in claim 3 wherein said piston type engine is a single or multi-cylinder engine.

5. The combination as claimed in claim 4 wherein said gear train has 2 elliptical or other special gears.

6. The combination as claimed in claim 5 wherein said gears cooperate to provide a maximum increase in peak torque of at least 2.0.

7. The combination as claimed in claim 1 wherein said device is a driven device and said gear train modifies the input force to improve the output of the driven device.

8. The combination as claimed in claim 7 wherein said driven device is an AC generator.

9. The combination as claimed in claim 8 wherein said drive force is a steam or wind turbine for said arrangement.

10. The combination as claimed in claim 8 wherein said drive force is a combustion engine.

11. The combination as claimed in claim 10 wherein said gear train includes two elliptical gears.

12. The combination as claimed in claim 1 wherein said gear train is a varying speed cyclic transmission paired to cooperate with a cyclically varying torque requirement or torque output of said device.

13. The combination as claimed in claim 1 wherein said gear train has a cyclically varying torque characteristic matched to a cyclically varying requirement for output of said device.

14. The combination as claimed in claim 1 wherein said gear train has at least two gears in said gear train, and said output device being a piston type internal combustion engine, and wherein each gear includes a gear segment paired to a respective piston-cylinder combination for increasing torque output during the power stroke in this cylinder.

15. A method of modifying a pulsing energy source device having an output shaft, said method comprising using a cyclically varying transmission having at least two gears, connecting one of said gears to the output shaft of the pulsing energy source device and aligned therewith such that during each pulse of the energy source device the transmission modifies the output to improve performance with respect to energy efficiency.

16. The method as claimed in claim 15 where the second gear is aligned with a driven device input and further improves performance with respect to energy efficiency.
